(19) United States
(12) Patent Application Publication
(10) Pub. No.: US 2014/0340652 A1
(43) Pub. Date: Nov. 20, 2014

(54) LIGHT SOURCE DEVICE AND PROJECTOR

(71) Applicant: SEIKO EPSON CORPORATION, Tokyo (JP)

(72) Inventor: Tetsuo SHIMIZU, Matsumoto-shi (JP)

(73) Assignee: SEIKO EPSON CORPORATION, Tokyo (JP)

(21) Appl. No.: 14/268,308

(22) Filed: May 2, 2014

(30) Foreign Application Priority Data
May 17, 2013 (JP) 2013-105366

(51) Int. Cl. G03B 21/16; F21V 29/00

(52) U.S. Cl. CPC G03B 21/16; F21V 29/004
USPC 353/52; 362/249.01

(57) ABSTRACT

A light source device includes a first light emitting element disposed in a first region on a substrate, and a second light emitting element disposed in a second region on the substrate, a temperature dependency of light emission characteristics of the first light emitting element is stronger than a temperature dependency of light emission characteristics of the second light emitting element, and a heat radiation performance in the first region is higher than a heat radiation performance in the second region.

### BACKGROUND

1. Technical Field

The present invention relates to a light source device and a projector.

2. Related Art

The projector is for modulating light emitted from a light source device using, for example, a liquid crystal panel to form an image, and then enlarging and projecting the image thus formed using a projection optical system.

In recent years, there has been known a technology of using a plurality of semiconductor laser elements arranged on a substrate as such a light source device as described above (see, e.g., JP-A-2012-164981).

However, in such a light source device using the plurality of semiconductor laser elements as described above, since the temperature dependency of the light emission characteristics in the semiconductor laser elements is not sufficiently considered, there is a problem that the light emission efficiency of the light source device is lowered as a whole.

### SUMMARY

An advantage of some aspects of the invention is to provide a light source device and a projector each reduced in degradation of the light emission efficiency.

A light source device according to an aspect of the invention includes a first light emitting element disposed in a first region on a substrate, and a second light emitting element disposed in a second region on the substrate, a temperature dependency of light emission characteristics of the first light emitting element is stronger than a temperature dependency of light emission characteristics of the second light emitting element, and a heat radiation performance in the first region is higher than a heat radiation performance in the second region.

According to the light source device related to this aspect of the invention, since the first light emitting element relatively strong in temperature dependency of the light emission characteristics is disposed in the first region relatively high in heat radiation performance, the rise in temperature of the first light emitting element can be reduced. As a result, the degradation of the light emission characteristics as a whole of the device can be reduced. Further, since the degradation of the light emission characteristics of the first light emitting element is reduced, it becomes unnecessary to dispose some additional first light emitting elements in order to compensate for the decrease in output due to the degradation of the light emission characteristics. Therefore, since the number of the first light emitting elements disposed on the substrate can be decreased, the size of the light source device can be decreased as a result.

The light source device described above may be configured such that the first region corresponds to an end portion of the substrate.

According to this configuration, since the first region is set in the end portion of the substrate only lightly affected by the confined heat, the heat radiation performance in the first region can easily and surely be improved.

The light source device described above may be configured such that a heat radiation member is disposed in the first region of the substrate.

According to this configuration, the heat radiation performance in the first region can easily and surely be improved.

The light source device described above may be configured such that at least one of the first light emitting element and the second light emitting element is disposed on the substrate via a stress relaxation member.

According to this configuration, it is possible to relax the stress caused on the mounting surface between the first or second light emitting element and the substrate due to, for example, the difference in linear expansion coefficient between the first or second light emitting element¥ and the substrate. Therefore, it is possible to stably mount the first and second light emitting elements on the substrate for a long period of time, and a longer life of the light source device can be achieved.

A projector according to another aspect of the invention includes the light source device described above, a light modulation device adapted to modulate light emitted from the light source device, and a projection optical system adapted to project the light modulated by the light modulation device.

According to the projector related to this aspect of the invention, since the light source device described above is provided, there is provided the projector, which is also high in light emission efficiency, and miniaturization of which is achieved.

### BRIEF DESCRIPTION OF THE DRAWINGS

The invention will be described with reference to the accompanying drawings, wherein like numbers reference like elements.

FIG. 1 is a diagram showing a schematic configuration of a projector according to a first embodiment of the invention.

FIG. 2 is a perspective view showing a schematic configuration of a light source device.

FIG. 3 is a diagram showing a schematic configuration of a light source device according to a second embodiment of the invention.

FIG. 4 is a diagram showing a schematic configuration of a light source device according to a modified example.

### DESCRIPTION OF EXEMPLARY EMBODIMENTS

Hereinafter, some embodiments of the invention will be described with reference to the accompanying drawings. The embodiments each show an aspect of the invention, and do not limit the scope of the invention, but can arbitrarily be modified within a technical concept of the invention. Further, in the drawings explained hereinafter, in order to make each constituent easy to understand, the actual structures and the structures of the drawings are made different from each other in scale size, number, and so on.

### First Embodiment

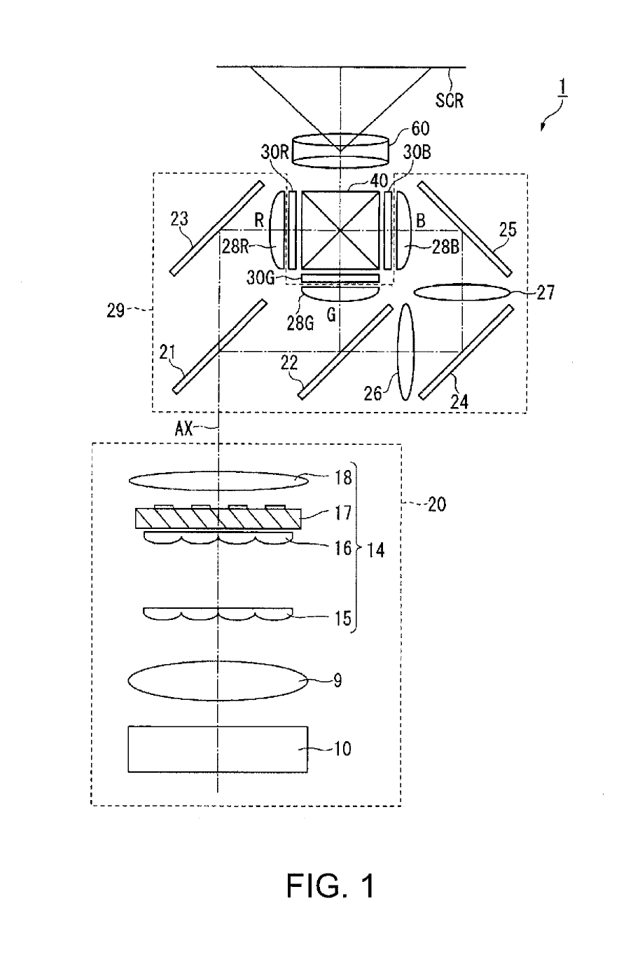

A projector according to a first embodiment of the invention will be explained. FIG. 1 is a diagram showing a schematic configuration of the projector. In the present embodiment, a projector 100 will be explained citing a projection type projector for projecting colored light beams, which include image information and are each generated by a light modulation panel, on a screen (a projection target surface) via a projection optical system as an example.

As shown in FIG. 1, the projector 100 is provided with an illumination optical system 20, a color separation light guide optical system 29, liquid crystal light modulation devices 30R, 30G, and 30B (a light modulation device), a cross dichroic prism 40, and a projection optical system 60, and projects an image light beam corresponding to an image signal input from the outside toward a screen SCR to thereby display the image on the screen SCR.

In the present embodiment, the illumination optical system 20 includes a light source device 10, a collecting lens 9, and an integrator optical system 14.

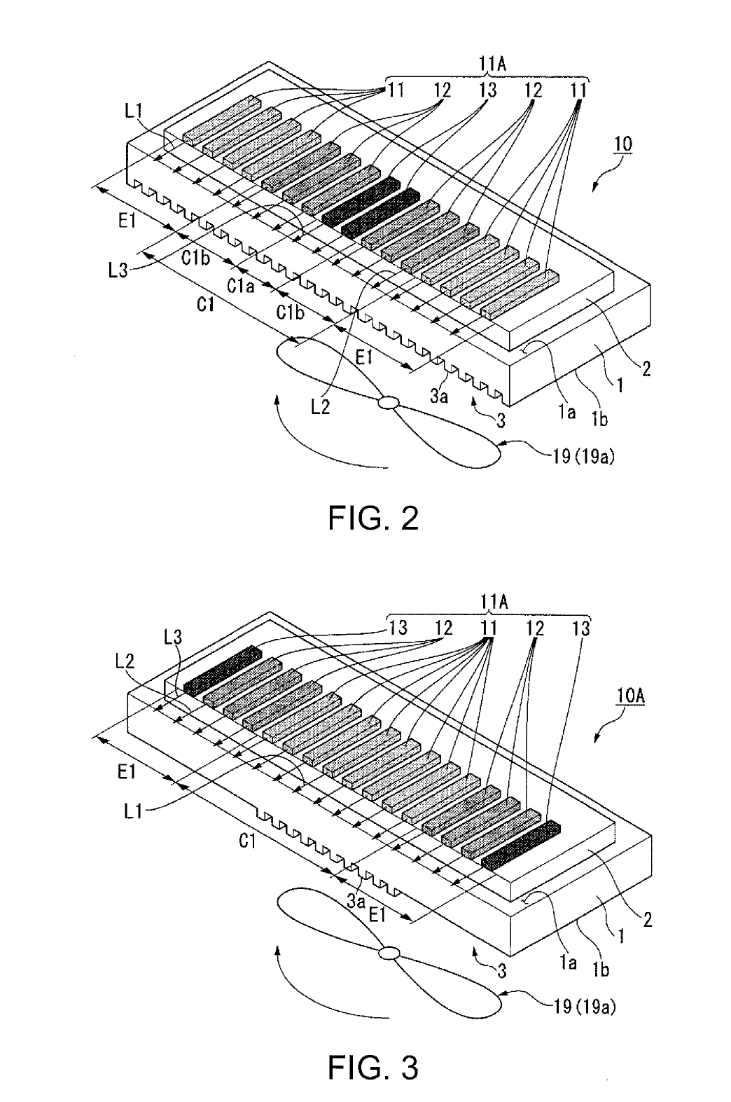

FIG. 2 is a perspective view showing a schematic configuration of the light source device 10.

As shown in FIG. 2, the light source device 10 is provided with a base plate (a substrate) 1, a sub-mount (a stress relaxation member) 2, red light sources 11, green light sources 12, and blue light sources 13. It should be noted that the red light sources 11, the green light sources 12, and the blue light sources 13 are hereinafter referred to collectively as light sources 11A in some cases. In order to efficiently cool the light sources 11A, it is preferable to provide a cooling mechanism 19.

The base plate 1 is a plate member having a rectangular planar shape and forming a frame of the overall configuration of the light source device 10. The base plate 1 is formed from a material high in thermal conductivity such as aluminum (Al) or copper (Cu).

The light sources 11A are mounted on a surface 1a side of the base plate 1 via the sub-mount 2. A heatsink structure 3 is disposed throughout the entire area of a reverse surface 1b of the base plate 1. The heatsink structure 3 is formed of a plurality of fins 3a. The plurality of fins 3a (the heatsink structure 3) are formed by processing the reverse surface 1b of the base plate 1. It should be noted that the heatsink structure 3 is formed of a member separated from the base plate 1. In this case, the member forming the heatsink structure provided with the plurality of fins is attached to the reverse surface 1b of the base plate 1 by bonding or fixation with bolts, screws, or the like.

The sub-mount 2 is used for relaxing the stress caused by the difference in linear expansion coefficient between the red light sources 11, the green light sources 12, or the blue light sources 13, and the base plate 1. The sub-mount 2 is formed of, for example, aluminum nitride (AlN). In the present embodiment, the sub-mount 2 is formed of a plate member smaller than the base plate 1 having the rectangular planar shape.

It should be noted that the material of the sub-mount 2 is not limited to the aluminum nitride, but any material, which can function as such a stress relaxation member as described above, can be selected. Although in the present embodiment, there is adopted the configuration in which the sub-mount 2 supports the light sources 11A in a lump, it is also possible to adopt a configuration of supporting the red light sources 11, the green light sources 12, and the blue light sources 13 with a plurality of sub-mounts 2, respectively.

The red light sources 11 are each formed of a semiconductor laser element for emitting a red light beam L1, which has a wavelength equal to or longer than 620 nm and shorter than 750 nm and substantially red color, from an end surface.

The green light sources 12 are each formed of a semiconductor laser element for emitting a green light beam L2, which has a wavelength equal to or longer than 495 nm and shorter than 570 nm and substantially green color, from an end surface.

The blue light sources 13 are each formed of a semiconductor laser element for emitting a blue light beam L3, which has a wavelength equal to or longer than 430 nm and shorter than 495 nm and substantially blue color, from an end surface.

The plurality of red light sources 11, the plurality of green light sources 12, and the plurality of blue light sources 13 are mounted on the base plate 1 via the sub-mount 2 along the longitudinal direction of the base plate 1. In the present embodiment, the light source device 10 has, for example, eight red light sources 11, six green light sources 12, and two blue light sources 13 mounted on the base plate 1. It should be noted that the pitch between the light sources 11A is set to, for example, about 1 mm. Therefore, in the present embodiment, it is arranged that the light sources 11A are disposed on the base plate 1 in a dense state.

Based on such a configuration as described above, the light source device 10 according to the present embodiment is arranged to have the numbers of the light sources different among the colors to thereby make it possible to emit white light as a whole including the red light beams L1, the green light beams L2, and the blue light beams L3.

Since the light sources 11A described above each generate heat due to emission of the laser beam, the temperature of the semiconductor laser element rises. The heat of the light sources 11A thus rising in temperature propagates to the base plate 1 via the sub-mount 2.

In the present embodiment, there is adopted a structure of cooling the base plate 1 using the cooling mechanism 19 described above. The cooling mechanism 19 includes a fan 19a for blowing a cooling gas such as air to the heatsink structure 3 described above disposed on the reverse surface 1b of the base plate 1. In the present embodiment, the heatsink structure 3 receives the heat from the base plate 1, and the cooling gas blown to the heatsink structure 3 takes the heat out of the heatsink structure 3 to thereby make it possible to cool the base plate 1.

Incidentally, in the present embodiment, the light sources 11A are disposed on the base plate 1 in the dense state as described above. In such a case, in the central portion of the base plate 1 in the longitudinal direction, the heat of the light sources 11A becomes difficult to be released, and therefore becomes apt to be confined. In contrast, in the end portions of the base plate 1 in the longitudinal direction, the heat of the light sources 11A becomes easy to be released to the outside, and therefore becomes difficult to be confined.

In the present embodiment, it is possible to rephrase that the base plate 1 has a region relatively low in heat radiation performance in a central portion C1 in the longitudinal direction, and regions each relatively high in heat radiation performance respectively in end portions E1 in the longitudinal direction. In other words, the central portion C1 of the base plate 1 corresponds to a second region described in the appended claims, and the end portion E1 of the base plate 1 corresponds to a first region described in the appended claims.

Incidentally, in the present embodiment, the semiconductor laser element constituting each of the red light sources 11 is a semiconductor laser element taking a GaAs substrate as a base (hereinafter referred to as a GaAs base in some cases). Further, the semiconductor laser element constituting each of the green light sources 12 and the blue light sources 13 is a semiconductor laser element taking a GaN substrate as a base (hereinafter referred to as a GaN base in some cases).

In general, it is known that the GaAs-base semiconductor laser element is strong in temperature dependency of the light emission characteristics compared to the GaN-base semiconductor laser element. Here, the strong temperature dependency of the light emission characteristics denotes the state in which, for example, the light emission efficiency is lowered or the hue of the laser beam is varied to make it unachievable to obtain the desired light in the case in which the temperature of the element has risen.

In contrast, in the present embodiment, the GaAs-base semiconductor laser elements (the red light sources 11) relatively strong in temperature dependency of the light emission characteristics are disposed in the end portions E1 (the first region), which are regions each relatively high in heat radiation performance in the base plate 1. Further, the GaN-base semiconductor laser elements (the green light sources 12 and the blue light sources 13) relatively weak in temperature dependency of the light emission characteristics are disposed in the central portion C1 (the second region), which is a region relatively low in heat radiation performance in the base plate 1. In other words, the red light sources 11 each correspond to a first light emitting element described in the appended claims, and the green light sources 12 and the blue light sources 13 each correspond to a second light emitting elements described in the appended claims.

It should be noted that the blue light sources 13 among the GaN-base semiconductor laser elements are weaker in temperature dependency of the light emission characteristics than the green light sources 12. Therefore, in the present embodiment, as shown in FIG. 2, the blue light sources 13 are disposed in a central portion C1a having the lowest heat radiation performance in the central portion C1, and the green light sources 12 are disposed in intermediate portions C1b in the central portion C1, which are located near to the end portions E1 and are therefore higher in heat radiation performance than the central portion C1a.

Going back to FIG. 1, the integrator optical system 14 is provided with a first lens array 15, a second lens array 16, a polarization conversion element 17, and an overlapping lens 18, and has a function of homogenizing the white light from the light source device 10.

The first lens array 15 and the second lens array 16 each have a plurality of lenses arranged two-dimensionally on a plane perpendicular to the optical axis of the light source device 10. Lenses of the first lens array 15 are disposed so as to correspond one-on-one to lenses of the second lens array 16. The shape of the plurality of lenses in the plane perpendicular to the optical axis of the light source device 10 is a similar shape (here, a roughly rectangular shape) to the shape of an illuminated area of each of the liquid crystal light modulation devices 30R, 30G, and 30B described later. The illuminated area is an area including the entire area where the plurality of pixels are arranged in each of the liquid crystal light modulation devices 30R, 30G, and 30B.

The polarization conversion element 17 has a polarization separation layer, a reflecting layer, and a retardation plate (all not shown), and converts each of partial light beams, which are split by the first lens array 15, into a substantially unique linearly-polarized light beam having a uniform polarization direction, and emits the resulted light beam. Here, the polarization separation layer transmits one of linearly-polarized components included in the white light without modification, and reflects the other of the linearly-polarized components in a direction perpendicular to an illumination light axis AX. Further, the reflecting layer reflects the other of the linearly-polarized components, which are reflected by the polarization separation layer, in a direction parallel to the illumination light axis AX. Further, the retardation plate converts the other of the linearly-polarized components reflected by the reflecting layer into the one of the linearly-polarized components.

The overlapping lens 18 is disposed so that the optical axis thereof coincides with the optical axis of the light source device 10, and collects the partial light beams from the polarization conversion element 17 to make the partial light beams overlap each other in the vicinity of an image forming area of each of the liquid crystal light modulation devices 30R, 30G, and 30B.

The color separation light guide optical system 29 is provided with dichroic mirrors 21, 22, reflecting mirrors 23 through 25, relay lenses 26, 27, and collecting lenses 28R, 28G, and 28B, and separates the light from the illumination device 10 into the red light beam, the green light beam, and the blue light beam, and then guides them to the liquid crystal light modulation devices 30R, 30G, and 30B, respectively. The dichroic mirrors 21, 22 are mirrors each having a wavelength selecting transmissive film, which reflects the light in a predetermined wavelength band and transmits the light in another wavelength band, and is formed on a transparent substrate. Specifically, the dichroic mirror 21 transmits a red light component and reflects a green light component and a blue light component, and the dichroic mirror 22 reflects the green light component and transmits the blue light component.

The reflecting mirror 23 is a mirror for reflecting the red light component, and the reflecting mirrors 24, 25 are mirrors for reflecting the blue light component. The relay lens 26 is disposed between the dichroic mirror 22 and the reflecting mirror 24, and the relay lens 27 is disposed between the reflecting mirror 24 and the reflecting mirror 25. Since the length of the light path of the blue light beam is larger than the length of the light paths of other colored light beams, the relay lenses 26, 27 are provided in order to prevent the degradation of the light beam efficiency due to, for example, the diffusion of the light beam. The collecting lenses 28R, 28G, and 28B collect the red light component reflected by the reflecting mirror 23, the green light component reflected by the dichroic mirror 22, and the blue light component reflected by the reflecting mirror 25 in the image forming areas of the liquid crystal light modulation devices 30R, 30G, and 30B, respectively.

The red light beam transmitted through the dichroic mirror 21 is reflected by the reflecting mirror 23, and then enters the image forming area of the liquid crystal light modulation device 30R for the red light beam via the collecting lens 28R. The green light beam reflected by the dichroic mirror 21 is further reflected by the dichroic mirror 22, and then enters the image forming area of the liquid crystal light modulation device 30G for the green light beam via the collecting lens 28G. The blue light beam having been reflected by the dichroic mirror 21 and then passed through the dichroic mirror 22 enters the image forming area of the liquid crystal light modulation device 30B for the blue light beam passing through the relay lens 26, the reflecting mirror 24, the relay lens 27, the reflecting mirror 25, and the collecting lens 28B in sequence.

The liquid crystal light modulation devices 30R, 30G, and 30B are each a transmissive liquid crystal light modulation device having the liquid crystal as an electro-optic material airtightly encapsulated between a pair of transparent glass substrates, and are each provided with, for example, polysilicon thin film transistors (TFT) as switching elements. The polarization directions of the colored light beams (the linearly-polarized light beams) transmitted through the entrance side polarization plates which are not shown, but described above, are modulated by the switching operations of the switching elements provided to the liquid crystal light modulation devices 30R, 30G, and 30B to thereby generate a red image light beam, a green image light beam, and a blue image light beam corresponding to the image signal, respectively.

The cross dichroic prism 40 combines the image light beams emitted from the respective exit side polarization plates which are not shown, but described above, to thereby form the color image. Specifically, the cross dichroic prism 40 is an optical member having a substantially cubic shape composed of four rectangular prisms bonded to each other, and on the substantially X-shaped interfaces on which the rectangular prisms are bonded to each other, there are formed dielectric multilayer films. The dielectric multilayer film formed on one of the substantially X-shaped interfaces is for reflecting the red light beam, and the dielectric multilayer film formed on the other of the interfaces is for reflecting the blue light beam. The red light beam and the blue light beam are respectively bent by these dielectric multilayer films to have the proceeding direction aligned with the proceeding direction of the green light beam, thus the three colored light beams are combined with each other. The projection optical system 60 projects the color image combined by the cross dichroic prism 40 toward the screen SCR in an enlarged manner.

As described hereinabove, according to the light source device 10 related to the present embodiment, since the red light sources 11 relatively strong in temperature dependency of the light emission characteristics are disposed in the end portions E1 of the base plate 1 each relatively high in heat radiation performance, and the green light sources 12 and the blue light sources 13 relatively weak in temperature dependency of the light emission characteristics are disposed in the central portion C1 of the base plate 1 relatively low in heat radiation performance, the degradation of the light emission characteristics as a whole of the light source device 10 can be reduced.

Further, since the degradation of the light emission characteristics of the red light sources 11 due to the rise in temperature is reduced, it becomes unnecessary to dispose some additional red light sources 11 in order to compensate for the decrease in output due to the degradation of the light emission characteristics. Therefore, since the number of the red light sources 11 disposed on the base plate 1 can be decreased, the size of the light source device 10 can be decreased as a result.

Further, since the light source device 10 according to the present embodiment has the light sources 11A mounted on the base plate 1 via the sub-mount 2, the stress caused due to the difference in linear expansion coefficient between the light sources 11A and the base plate 1 can be relaxed. Therefore, it is possible to stably mount the light sources 11A on the base plate 1 for a long period of time, and a longer life of the light source device 10 can be achieved.

Further, according to the projector 100 related to the present embodiment, since the light source device 10 described above is provided, there can be provided the projector 100, which is also high in light emission efficiency, and miniaturization of which is achieved.

### Second Embodiment

Subsequently, a second embodiment of the invention will be explained.

Although in the first embodiment, there is cited a case in which the red light sources 11 are disposed in the end portions E1 where the heat is difficult to be confined due to the structure of the base plate 1 and therefore a relatively high heat radiation performance is obtained, and the green light sources 12 and the blue light sources 13 are disposed in the central portion. C1 where a relatively low heat radiation performance is obtained, the present embodiment is significantly different from the first embodiment in the point that the cooling mechanism 19 selectively cools the central portion C1 to thereby improve the heat radiation performance to a level higher than the level of the heat radiation performance of the end portions E1, and thus the central portion C1 is defined as a first region and the end portion E1 is defined as the second region, but is the same as the first embodiment in other parts of the configuration. Therefore, constituents and members the same as those of the first embodiment will be denoted with the same reference symbols, and the detailed explanation thereof will be omitted.

FIG. 3 is a diagram showing a schematic configuration of a light source device 10A according to the present embodiment.

As shown in FIG. 3, the light source device 10A is provided with the base plate 1, the sub-mount 2, and the light sources 11A. In the present embodiment, the reverse surface 1b of the base plate 1 is partially provided with the heatsink structure 3. The heatsink structure 3 is selectively disposed on the reverse surface 1b in the central portion C1 of the base plate 1. In order to efficiently cool the light sources 11A, it is preferable to provide the cooling mechanism 19.

In the present embodiment, the cooling mechanism 19 blows the cooling gas such as air to the reverse surface 1b of the base plate 1 using the fan 19a. Since the cooling gas takes the heat out of the heatsink structure 3, it is possible to more efficiently cool the central portion C1 of the base plate 1 than the end portions E1 thereof.

As described above, in the present embodiment, it is possible to rephrase that the base plate 1 has a region relatively high in heat radiation performance in the central portion C1 in the longitudinal direction, and regions each relatively low in heat radiation performance respectively in the end portions E1 in the longitudinal direction. In other words, in the present embodiment, the central portion C1 of the base plate 1 corresponds to the first region described in the appended claims, and the end portion E1 of the base plate 1 corresponds to the second region described in the appended claims.

In the present embodiment, there is adopted a configuration in which the GaAs-base semiconductor laser elements (the red light sources 11) relatively strong in temperature dependency of the light emission characteristics are disposed in the central portion C1 (the first region), which is the region relatively high in heat radiation performance in the base plate 1, and the GaN-base semiconductor laser elements (the green light sources 12 and the blue light sources 13) relatively weak in temperature dependency of the light emission characteristics are disposed in the end portions E1 (the second region), which are the regions relatively low in heat radiation performance in the base plate 1.

As described above, the present embodiment is arranged to have the red light sources 11, the green light sources 12, and the blue light sources 13 arranged in this order from the central portion C1 toward each of the end portions E1 of the base plate 1 via the sub-mount 2.

According also to the light source device 10A related to the present embodiment, since the red light sources 11 relatively strong in temperature dependency of the light emission characteristics are disposed in the central portion C1 of the base plate 1 provided with the heatsink structure 3 and therefore relatively high in heat radiation performance, and the green light sources 12 and the blue light sources 13 relatively weak in temperature dependency of the light emission characteristics are disposed in the end portions E1 of the base plate 1 relatively low in heat radiation performance, the degradation of the light emission characteristics as a whole of the light source device 10A can be reduced.

### Modified Examples

It should be noted that the invention is not limited to the embodiments described above, but can be modified within the scope or the spirit of the invention. The modified examples described hereinafter, for example, are possible.

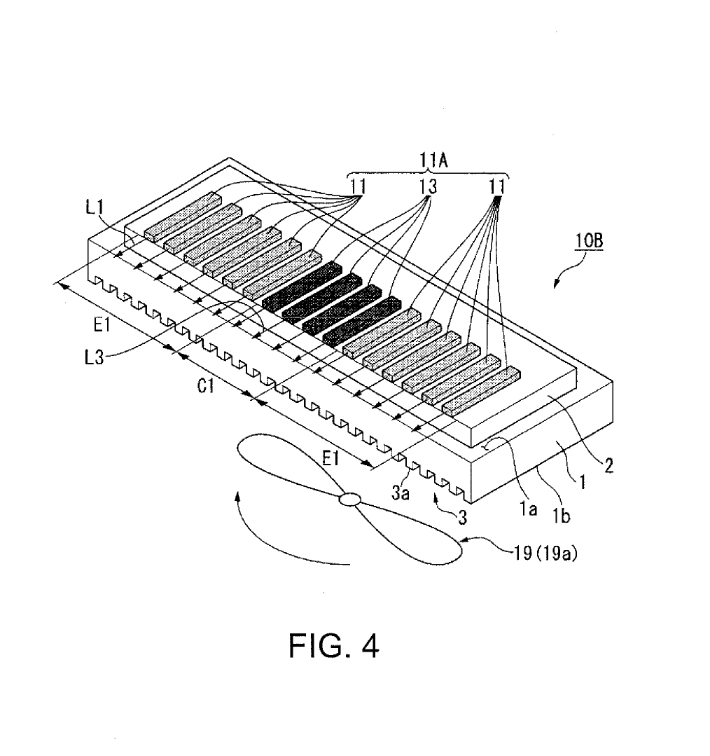

Although in the embodiments described above, there is described the case of applying the light source device 10 to the projector 100, it is also possible to use the light source device 10 as an illumination device. In the case of using the light source device 10 as the illumination device as described above, the light source device is not required to emit the white light. For example, it is also possible to use such a device having only the red light sources 11 and the blue light sources 13 mounted on the base plate 1 via the sub-mount 2 as shown in FIG. 4 as an illumination device 10B. In this case, the illumination device 10B is arranged to be able to emit a violet light beam including the red light beams L1 and the blue light beams L3. It should be noted that the illumination device 10B can also be arranged to drive only either one of the red light sources 11 and the blue light sources 13 to emit only either one of the red light beams L1 and the blue light beams L3.

In the present modified example, the illumination device 10B has four blue light sources 13 disposed in the central portion C1 of the base plate 1, and six red light sources 11 disposed in each of the two end portions E1 of the base plate 1.

According also to the present modified example, since the red light sources 11 relatively strong in temperature dependency of the light emission characteristics are disposed in the end portions E1 of the base plate 1 each relatively high in heat radiation performance, and the blue light sources 13 relatively weak in temperature dependency of the light emission characteristics are disposed in the central portion C1 of the base plate 1 relatively low in heat radiation performance, the degradation of the light emission characteristics as a whole of the illumination device 10B can be reduced.

Further, although in the embodiments described above, there is cited the case in which the light sources 11A are mounted on the base plate 1 via the sub-mount 2 as an example, it is also possible to mount the light sources 11A directly on the base plate 1 without using the sub-mount 2.

Further, although in the embodiments described above, there is explained the example of using the liquid crystal light modulation devices as the light modulation device, the invention is not limited to the example. Any devices for modulating the incident light in accordance with the image signal, in general, can be adopted as the light modulation device, and micromirror light modulation devices and so on can also be adopted. As the micromirror light modulation device, for example, a digital micromirror device can be used.

Further, although in the embodiments described above, the transmissive projector is explained as an example of the projector, the invention is not limited to the example. The invention can also be applied to, for example, a reflective projector. It should be noted here that “transmissive” denotes that the light modulation device is a type of transmitting the light such as a transmissive liquid crystal display device, and “reflective” denotes that the light modulation device is a type of reflecting the light such as a reflective liquid crystal display device. Also in the case in which the invention is applied to the reflective projector, the same advantages as in the case with the transmissive projector can be obtained.

Further, although in the embodiments described above, the three-panel projector is explained, a single-panel projector such as a field sequential type can also be adopted as the projector described above. The projector according to the embodiments described above can also be used for a head-mounted display, a head-up display, or the like.

The entire disclosure of Japanese Patent Application No. 2013-105366, filed on May 17, 2013 is expressly incorporated by reference herein.

What is claimed is:

1. A light source device comprising:
a substrate;
a first light emitting element disposed in a first region on the substrate; and
a second light emitting element disposed in a second region on the substrate;
wherein a temperature dependency of light emission characteristics of the first light emitting element is stronger than a temperature dependency of light emission characteristics of the second light emitting element, and
a heat radiation performance in the first region is higher than a heat radiation performance in the second region.

2. The light source device according to claim 1, wherein
the first region corresponds to an end portion of the substrate.

3. The light source device according to claim 1, wherein
a heat radiation member is disposed in the first region of the substrate.

4. The light source device according to claim 1, wherein
at least one of the first light emitting element and the second light emitting element is disposed on the substrate via a stress relaxation member.

5. A projector comprising:
a light source device according to claim 1;
a light modulation device adapted to modulate light emitted from the light source device; and
a projection optical system adapted to project the light modulated by the light modulation device.

6. A projector comprising:
a light source device according to claim 2;
a light modulation device adapted to modulate light emitted from the light source device; and
a projection optical system adapted to project the light modulated by the light modulation device.

7. A projector comprising:
a light source device according to claim 3;
a light modulation device adapted to modulate light emitted from the light source device; and
a projection optical system adapted to project the light modulated by the light modulation device.

8. A projector comprising:
a light source device according to claim 4;
a light modulation device adapted to modulate light emitted from the light source device; and
a projection optical system adapted to project the light modulated by the light modulation device.
